(19) United States
(12) Patent Application Publication
(10) Pub. No.: US 2026/0237288 A1
(43) Pub. Date: Aug. 13, 2026

(54) METHOD AND DEVICE FOR MONITORING A PERSON

(71) Applicants: OSO-AI, Brest (FR); SORBONNE UNIVERSITE, Paris (FR); INSTITUT NATIONAL DE LA SANTE ET DE LA RECHERCHE MEDICALE, Paris (FR); ASSISTANCE PUBLIQUE HOPITAUX DE PARIS, Paris (FR)

(72) Inventors: Nathan Palluau, Boulogne-Billancourt (FR); Olivier Menut, Saint-Martin-d'Hères (FR); Capucine Morelot-Panzini, Saint-Maur (FR); Thomas Similowski, Issy-les-Moulineaux (FR)

(73) Assignees: OSO-AI, Brest (FR); SORBONNE UNIVERSITE, Paris (FR); INSTITUT NATIONAL DE LA SANTE ET DE LA RECHERCHE MEDICALE, Paris (FR); ASSISTANCE PUBLIQUE HOPITAUX DE PARIS, Paris (FR)

(21) Appl. No.: 19/154,883

(22) PCT Filed: Feb. 7, 2024
(86) PCT No.: PCT/EP2024/052957

§ 371 Date: Aug. 8, 2025

(30) Foreign Application Priority Data
Feb. 8, 2023 (FR) FR2301193

(51) Int. Cl. G08B 31/00; G08B 21/04; G08B 29/18

(52) U.S. Cl. CPC G08B 31/00; G08B 21/043; G08B 29/186

(57) ABSTRACT

The method for monitoring a person includes a) recording sounds produced by the person during a recording period; b) using a processing unit, implementing a classification algorithm for each sound recorded during the recording period, so as to classify each recorded sound into a set of classes, the set of classes including at least a first class of interest, representative of respiratory abnormalities in the person and/or a change in their breathing pattern; and c) depending on the number of sounds classified in the first class of interest, emitting an alert signal, informing of a potential risk of the person falling.

### TECHNICAL FIELD

The technical field of the invention relates to monitoring a person with the aim of anticipating a fall.

### BACKGROUND ART

There are many devices for detecting when a person has fallen. These devices usually include motion sensors, such as accelerometers. The occurrence of a fall is detected based on the accelerometer measurements. The devices may be configured to generate an automatic alert signal to third parties responsible for monitoring the person or to emergency services.

However, these devices, however effective they may be, only detect a person's fall after it has occurred.

US2019/197861 describes a device configured to detect a person's fall based on a change in the height at which a person is moving. The fall may be confirmed by detecting that the person is lying down or by sounds generated by the person.

It is much more difficult to anticipate the occurrence of a fall. This is what the invention described below addresses.

### SUMMARY OF THE INVENTION

A first object of the invention is a method for monitoring a person, the method comprising:
a) recording sounds produced by the person during a recording period;
b) using a processing unit, implementing a classification algorithm for each sound recorded during the recording period, so as to classify each recorded sound into a set of classes, the set of classes comprising at least a first class of interest, representative of a respiratory anomaly or a change in the person's breathing;
c) depending on the number of sounds classified in the first class of interest, emitting an alert signal, informing of a potential risk of the person falling.

According to one possibility:
the recording period is subdivided into several processing periods;
step b) includes a frequency analysis of the sound recorded in each processing period, in order to form input data for the classification algorithm;
in step b), for each processing period, the classification algorithm assigns a score to each class, the score being representative of a probability of belonging to that class;
in step c), the alert signal is emitted based on a first cumulative score, the first cumulative score corresponding to the sum of the scores assigned to the first class of interest during each processing period.

Step b) may include:
taking into account sounds recorded during a processing period;
determining elementary windows extending within the processing period;
performing a frequency analysis in each elementary window, so as to form, for each elementary window, a frequency spectrum of the sound recorded in the elementary window;
using each frequency spectrum as input data for the classification algorithm.

The classification algorithm may be a supervised learning artificial intelligence algorithm. The classification algorithm may include a convolutional neural network coupled to a multilayer perceptron.

According to one possibility,
the set of classes includes a second class of interest, representative of sheet movements generated by the movement of the person when the person is in bed;
step c) includes emitting the alert signal based on a number of sounds classified in the second class of interest.

According to one possibility,
in step c), the alert signal is emitted based on a second cumulative score (C2), the second cumulative score corresponding to a sum of the scores assigned to the second class of interest during each processing period.

In step a), the recording period may include one night or several successive nights.

Step c) may implement a classification model, fed by the number of sounds classified in the first class of interest.

A second object of the invention is a device for monitoring a person, comprising:
a microphone, configured to record a sound generated by the person during a recording period;
a processing unit programmed to implement steps b) and c) of a method according to the first object of the invention from the sounds recorded during the recording period, so as to prevent a fall by the person based on sounds generated by the person during the recording period.

A third object of the invention is a device for detecting a person's fall, comprising:
a sensor configured to detect movement or sound of a person;
a detection unit programmed to detect a fall of the person based on a characteristic of a signal resulting from the sensor, the detection unit being configured to indicate a fall when the characteristic exceeds a detection threshold;
the device being characterized in that the fall detection device is connected to a monitoring device (1) according to the second object of the invention, the detection unit being programmed so that the detection threshold is adjusted according to an alert signal emitted by the processing unit of the monitoring device.

The sensor may be an activity sensor, in which case the signal resulting from the sensor is a signal representative of a movement of the person. The sensor may be a microphone, in which case the signal resulting from the sensor is a signal representative of a sound emitted by the person.

### BRIEF DESCRIPTION OF THE DRAWINGS

The invention will be better understood upon reading the description of the examples of embodiments presented below, in conjunction with the figures listed below.

FIG. 1 schematically illustrates the main components of a device according to the invention.

FIG. 2 shows examples of recorded frequency spectra corresponding to sounds emitted by a person.

FIG. 3 shows the main steps in implementing the invention.

FIG. 4 shows a use of a device according to the invention coupled with a device for detecting a person's fall.

### DETAILED DESCRIPTION OF PARTICULAR EMBODIMENTS

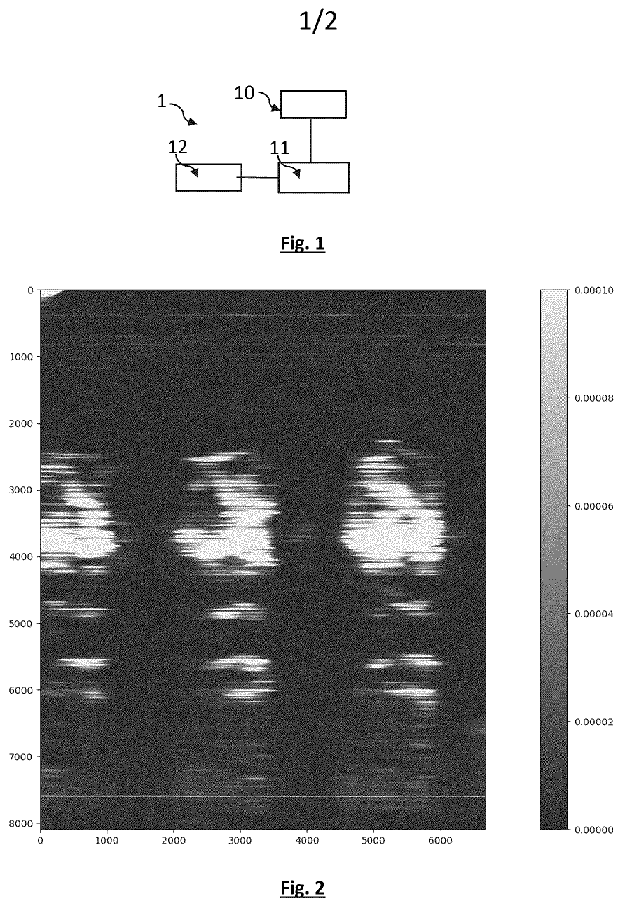

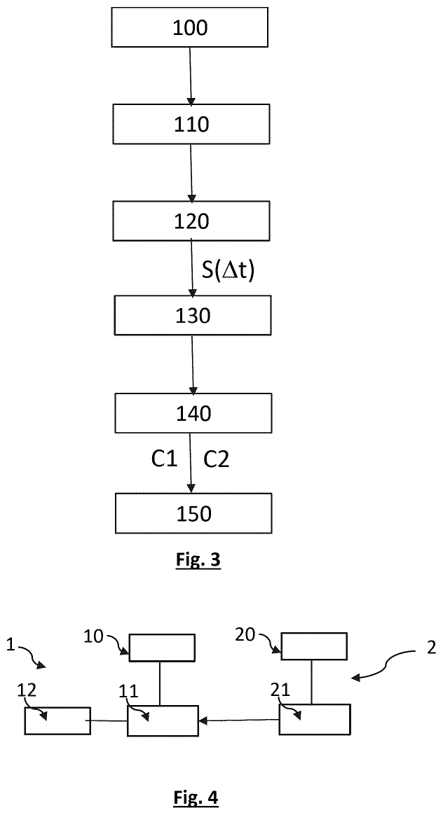

FIG. 1 shows an example of a monitoring device 1 according to the invention. The device comprises a microphone 10, arranged to detect sounds generated by a person. The microphone may be fixed in position, for example in a room in which the person moves around. This may be a bedroom, for example. The sounds detected by the microphone are transmitted to a processing unit 11. The processing unit 11 is connected to the microphone 10 by a wireless or wired connection. The processing unit comprises a microprocessor programmed to execute instructions in order to implement the method, the main steps of which are summarized in connection with FIG. 3. The processing unit is connected to a memory 12 in which the said instructions are stored.

An important aspect of the invention stems from the inventors' observation that a person's fall may be preceded by particular sounds generated by the person prior to the fall, for example during one or more nights preceding the fall.

It is easy to record the sound generated by a person during the night. The inventors recorded sounds generated by different people during consecutive nights and focused their analysis of these sounds on the days and nights preceding the occurrence of a fall. They found that there was a statistical relationship between the occurrence of falls, on the one hand, and, on the other hand, the observation, on the recordings, of the appearance of sounds suggesting the presence of respiratory anomalies in the person recorded, or an increase in the frequency of such sounds over time, or changes over time in the person's breathing pattern. “Respiratory anomalies” refers to breathing pattern marked by an increase in frequency, variations in regularity, changes in the temporal characteristics of inhalation and exhalation, changes in their sounds, or the appearance of specific sounds synchronized with breathing (e.g. crackles, moans, wheezes, etc.), or the appearance of sounds superimposed to breathing (coughing, sniffing, nose blowing, sighing, etc.). These anomalies may occur individually or in combination. They may be analyzed separately as distinct entities. They can also be interpreted globally and qualitatively to convey, to the human ear, an impression of shortness of breath (dyspnea), breathing difficulties, respiratory discomfort, or even respiratory distress.

To reach this conclusion, the inventors conducted an analysis of sounds produced by various individuals over several consecutive nights, particularly consecutive nights preceding a fall.

Each sound recorded by the microphone was subjected to frequency analysis using 1,454 frequency bands ranging from 16 Hz to 8,000 Hz. The frequency analysis was performed on an elementary time window Δt of 67 ms, with a temporal shift of 23 ms between two consecutive elementary windows. Thus, there is an overlap between two successive elementary windows. This yielded a frequency spectrum S(Δt) for each elementary window.

FIG. 2 shows a set of consecutive frequency spectra from an individual with respiratory anomalies of the wheezing type. In FIG. 2, the y-axis corresponds to the frequency. The x-axis corresponds to a number assigned to each elementary window.

Sequences S of consecutive spectra, established over a processing period T of 9.6 seconds, were used as input data for a neural network with convolutional layers, similar in design to those of the ResNet architecture, where ResNet stands for Residual Networks. This network had five convolution layers. A description of the ResNet network is given in Chen F. et al “Assessing the effects of convolutional neural network architectural factors on model performance for remote sensing image classification: An in-depth investigation.” The convolution layers enable the extraction of features from the frequency spectra forming the input data. The extracted features are processed by a multilayer perceptron.

The output of the multilayer perceptron represents a probability of belonging to several classes. Each class is representative of sounds emitted by the person: domestic sounds (e.g., bed sheets rustling, footsteps, water running in the bathroom, etc.), physiological sounds (coughing, snoring, wheezing, gasping, etc.). The sounds corresponding to each 9.6-second processing period T were manually annotated. The different sounds recorded, corresponding to a 9.6-second sequence, were manually categorized into the different available classes.

The annotations were carried out by different operators. For each class and for each processing period T, the proportion of operators who classified each sound corresponding to the sequence in the said class constituted the target of the neural network. The number of operators ranged varied between 3 to 7.

The neural network was trained using sounds recorded by 559 microphones placed in individual rooms in a residential care facility for elderly individuals. The neural network underwent a test phase comprising 141,139 annotated sequences that had not been used during the neural network training. In the “breathing” class, representative of sounds indicating abnormal breathing, the correlation coefficient reached 0.79+/−0.02 .

Thus, the neural network, based on a combination of convolution layers and a multilayer perceptron, can classify a sequence of frequency spectra representative of a person's activity or state during a 9.6-seconds treatment period T.

Sound recordings were collected during 2,398 nights. Among these:
a set of 2,000 nights, during which no fall of the monitored person occured;
a set of 398 nights, during which the monitored person fell.

For each night in the set, a set of recordings was formed, including the night itself and the four preceding nights. Thus, the set of recordings associated with each night included recordings from a total of five consecutive nights.

Based on these sets of recordings associated with each night, a training set consisting of 80% of the nights, and a test set consisting of the remaining 20% of nights, were created. The nights were randomly assigned to the training set and the test set.

The set of recordings was segmented into processing periods T of 9.6 seconds. For each processing period T, frequency spectra S(Δt) were formed over time windows of 67 ms, shifted by 23 ms from one another. The spectra S(Δt) acquired during each processing period T form a sequence of spectra S, which was used as input data for the neural network described above.

The score corresponding to all classes was recorded. The scores corresponding to each class of all sequences formed from the same set of five nights were accumulated to form input data for a training model. Thus, each input data for the training model was a vector, each term of which was associated with a class and was formed by the sum of the scores for that class resulting from the neural network over all the sequences forming the recording set.

The classification model was trained to predict an output (1 in the event of a fall, 0 otherwise) based on the input data. The training model chosen was a training model using the gradient boosting method programmed in the open source (freely accessible) algorithm XGboost (eXtreme Gradient Boosting), in the Python programming environment.

The average purity gain associated with each class was evaluated. The purity gain reflects the influence of a class on the prediction of the result provided by the classification model. A relationship was thus studied between the cumulative score of each class during the four nights preceding the night in question. The inventors noticed that two classes stood out: a first class of interest, corresponding to the “breathing” class, and, to a lesser extent, a second class of interest, corresponding to the “sheet noise” class. The breathing class reflects the presence of respiratory anomalies, indicative of “breathing difficulties,” as previously mentioned. The “sheet noise” class indicates probable restlessness of the person during sleep.

Thus, it appears that the emission of nocturnal sounds by the monitored person, indicating breathing difficulties and, to a lesser extent, restlessness during sleep leading to sheet noise, may be considered as indicative of a risk of the person falling during the subsequent night. This finding, resulting from the use of the classification model, is an important aspect of the invention. It enables the anticipation of a fall based on a simple sound recording. A notable feature is that the sounds used are not directly correlated with the person's walking. A sound directly correlated with walking refers to a sound produced by the person's footsteps on the floor. The sounds used are sounds of respiratory origin or sounds generated by the person's motor activity while lying in bed.

Depending on the scores in the first interest class “breathing” and/or the second interest class “sheet noise,” the device may generate an alert signal to third parties responsible for monitoring the person. The aim is to increase the level of vigilance towards the monitored person in order to prevent a fall from occurring.

FIG. 3 summarizes the main steps of an example of implementation of the invention. In this example, the recording of the person is carried out during the night. However, the invention may be implemented to carry out either daytime or nighttime recordings.
Step 100: Recording sounds in the vicinity of a person being monitored. This may involve recording in a room occupied by the person, for example in their bedroom. The sounds are recorded during a recording period, extending, for example, over one night or several nights.
Step 110: Segmentation of the recorded sound into processing periods T, for example during 9.6 seconds.
Step 120: Frequency analysis of the sound recorded during each processing period. As previously described, the frequency analysis is performed on elementary windows Δt, for example 67 ms. This provides as many frequency spectra S(Δt) as there are elementary windows. Step 120 may be implemented by the processing unit 11.
Step 130: based on the frequency analysis performed during each processing period, formation of input data S for a supervised learning artificial intelligence algorithm. The latter may be a neural network comprising a combination of convolution layers and a multilayer perceptron, as previously described. The output of the algorithm is a score, associated with different classes, each class being representative of a type of sound produced by the monitored person. A first class is representative of abnormal breathing. Preferably, a second class is representative of sheet noise, or more generally noise related to the person's movements in bed. The input data S may be a set of frequency spectra established during step 120, with or without overlapping elementary windowsΔt. Step 130 is implemented by processing unit 11.
Step 140: analysis of the output of the algorithm implemented in step 130. During this analysis, an initial cumulative score C1 is established, corresponding to the cumulative score in the “breathing” class over several time periods. The time periods may extend over one or more successive nights.
Step 140 may include determining a second cumulative score C2 in the “sheet noise” class, representative of the movement of the monitored person in bed.
Step 150: Based on the cumulative score, or each cumulative score, resulting from step 140, an alert signal is generated. The alert signal is generated based on the value taken by the cumulative score, or by each cumulative score, resulting from step 140. For example, the alert signal is emitted when the cumulative score, or when each cumulative score, exceeds an alert threshold. Step 150 implements the classification model described above. The first cumulative score and the second cumulative score form the input data for the classification model. The output of the classification model is a scalar, preferably between 0 and 1, which represents the probability of a fall occurring.

Taking into account cumulative scores over a predetermined number of previous nights allows account for a temporal evolution in the occurrences of the first class or second.

The alert signal is intended to alert a third party, responsible for the monitored person, of an increased risk of falling during the following night. The third party may be a family contact, or healthcare staff when the monitored person is in a medical facility, or remote monitoring staff, such as staff from home surveillance service providers.

The monitoring device 1 described above may be coupled with a device for detecting a person's fall 2. The coupling is illustrated in FIG. 4. As mentioned in the prior art, there are many devices for detecting a person's fall. This type of device is designed to be worn by a person. It usually comprises a sensor 20, for example an actimetry sensor, configured to measure movement of the person. The actimetry sensor may, for example, comprise an accelerometer or a gyrometer or a magnetometer. In addition or as an alternative, the sensor 20 may be a sound sensor. In this case, all or part of the monitoring is based on the detection of sounds representative of a fall. This may be the detection of a noise produced by the fall itself or a sound generated by the person who has fallen.

The fall detection device 2 comprises a detection unit 21, programmed to detect a fall of the person, based on a characteristic of a signal resulting from the activity sensor. The detection unit 21 is configured to indicate a fall when the characteristic exceeds a detection threshold. For example, when the sensor is an accelerometer-, a fall is detected when the acceleration measured vertically exceeds a certain threshold.

When the fall detection device is based on sound detection, the detection threshold may be a characteristic of the detected sound, for example an amplitude or spectral power in a predetermined frequency band, said frequency band corresponding to the sound produced by a person falling. The sound may be due to the impact of the body on the ground, or to a sound produced by a person, for example a cry, during or following the fall.

The monitoring device may advantageously be combined with the fall detection device. When an alert signal is emitted, the detection threshold of the detection unit may be adjusted to increase the fall detection sensitivity due to an increased risk of the monitored person falling.

1. A method for monitoring a person, the method comprising
a) recording sounds produced by the person during a recording period;
b) using a processing unit, implementing a classification algorithm for each sound recorded during the recording period, so as to classify each recorded sound among a set of classes, the set of classes comprising at least a first class of interest, representative of a respiratory anomaly or a change in the breathing of the person; and
c) depending on a number of sounds classified in the first class of interest, emitting an alert signal, informing of a potential risk of the person falling.

2. The method according to claim 1, wherein:
the recording period is subdivided into several processing periods;
the implementing of the classification algorithm b) comprises a frequency analysis of a sound recorded in each processing period, so as to form input data for the classification algorithm;
in the implementing of the classification algorithm b), for each processing period, the classification algorithm assigns a score to each class, the score being representative of a probability of belonging to the class; and
in the emitting of the alert signal c), the alert signal is emitted according to a first cumulative score, the first cumulative score corresponding to a sum of the scores assigned to the first class of interest during each processing period.

3. The method according to claim 2, wherein the implementing of the classification algorithm b) comprises:
taking into account sounds recorded during a processing period;
determining elementary windows extending within the processing period;
performing a frequency analysis in each elementary window, so as to form, for each elementary window, a frequency spectrum of a sound recorded in the elementary window; and
using each frequency spectrum as input data for the classification algorithm.

4. The method according to claim 2, wherein the classification algorithm is a supervised learning artificial intelligence algorithm.

5. The method according to claim 4, wherein the classification algorithm comprises a convolutional neural network coupled to a multilayer perceptron.

6. The method according to claim 1, wherein
the set of classes includes a second class of interest, representative of sheet movements generated by a movement of the person when the person is in bed;
the emitting of the alert signal c) comprises emitting the alert signal based on a number of sounds classified in the second class of interest.

7. The method according to claim 2, wherein
the set of classes includes a second class of interest, representative of sheet movements generated by a movement of the person when the person is in bed;
the emitting of the alert signal c) comprises emitting the alert signal based on a number of sounds classified in the second class of interest; and
in the emitting of the alert signal c), the alert signal is emitted based on a second cumulative score, the second cumulative score corresponding to a sum of the scores assigned to the second class of interest during each processing period.

8. The method according to claim 1, wherein in the recording of the sounds a), the recording period includes one or more successive nights.

9. The according to claim 1, wherein the emitting of the alert signal c) implements a classification model fed by a number of sounds classified in the first class of interest.

10. A monitoring device for monitoring a person, the monitoring device comprising
a microphone, configured to
a) record sounds generated by the person during a recording period; and
a processing unit programmed to
b) from the sounds recorded during the recording period, implement a classification algorithm for each sound recorded during the recording period, so as to classify each recorded sound among a set of classes, the set of classes comprising at least a first class of interest, representative of a respiratory anomaly or a change in the breathing of the person; and
c) depending on a number of sounds classified in the first class of interest, emit an alert signal, informing of a potential risk of the person falling,
so as to prevent a fall of the person based on the sounds generated by the person during the recording period.

11. A fall detection device, comprising:
a sensor configured to detect movement or sound of a person; and
a detection unit programmed to detect a fall of the person based on a characteristic of a signal resulting from the sensor, the detection unit being configured to indicate a fall when the characteristic exceeds a detection threshold;
wherein the fall detection device is connected to a monitoring device for monitoring a person, the monitoring device comprising
a microphone, configured to
a) record sounds generated by the person during a recording period; and
a processing unit programmed to
b) from the sounds recorded during the recording period, implement a classification algorithm for each sound recorded during the recording period, so as to classify each recorded sound among a set of classes, the set of classes comprising at least a first class of interest, representative of a respiratory anomaly or a change in the breathing of the person; and
c) depending on a number of sounds classified in the first class of interest, emit an alert signal, informing of a potential risk of the person falling,
so as to prevent a fall of the person based on the sounds generated by the person during the recording period,
wherein the detection unit of the fall detection device is programmed so that the detection threshold is adjusted according to an alert signal emitted by the processing unit of the monitoring device.

12. The method according to claim 3, wherein the classification algorithm is a supervised learning artificial intelligence algorithm.

13. The method according to claim 12, wherein the classification algorithm comprises a convolutional neural network coupled to a multilayer perceptron.

14. The method according to claim 2, wherein
the set of classes includes a second class of interest, representative of sheet movements generated by a movement of the person when the person is in bed;
the emitting of the alert signal c) comprises emitting the alert signal based on a number of sounds classified in the second class of interest.

15. The method according to claim 3, wherein
the set of classes includes a second class of interest, representative of sheet movements generated by a movement of the person when the person is in bed;
the emitting of the alert signal c) comprises emitting the alert signal based on a number of sounds classified in the second class of interest.

16. The method according to claim 4, wherein
the set of classes includes a second class of interest, representative of sheet movements generated by a movement of the person when the person is in bed;
the emitting of the alert signal c) comprises emitting the alert signal based on a number of sounds classified in the second class of interest.

17. The method according to claim 5, wherein
the set of classes includes a second class of interest, representative of sheet movements generated by a movement of the person when the person is in bed;
the emitting of the alert signal c) comprises emitting the alert signal based on a number of sounds classified in the second class of interest.

18. The method according to claim 3, wherein
the set of classes includes a second class of interest, representative of sheet movements generated by a movement of the person when the person is in bed;
the emitting of the alert signal c) comprises emitting the alert signal based on a number of sounds classified in the second class of interest; and
in the emitting of the alert signal c), the alert signal is emitted based on a second cumulative score, the second cumulative score corresponding to a sum of the scores assigned to the second class of interest during each processing period.

19. The method according to claim 4, wherein
the set of classes includes a second class of interest, representative of sheet movements generated by a movement of the person when the person is in bed;
the emitting of the alert signal c) comprises emitting the alert signal based on a number of sounds classified in the second class of interest; and
in the emitting of the alert signal c), the alert signal is emitted based on a second cumulative score, the second cumulative score corresponding to a sum of the scores assigned to the second class of interest during each processing period.

20. The method according to claim 5, wherein
the set of classes includes a second class of interest, representative of sheet movements generated by a movement of the person when the person is in bed;
the emitting of the alert signal c) comprises emitting the alert signal based on a number of sounds classified in the second class of interest; and
in the emitting of the alert signal c), the alert signal is emitted based on a second cumulative score, the second cumulative score corresponding to a sum of the scores assigned to the second class of interest during each processing period.
